(19) United States
(12) Patent Application Publication
(10) Pub. No.: US 2010/0143868 A1
(43) Pub. Date: Jun. 10, 2010

(54) Method for the precise fabrication of dental components using a sintering or selective laser melting process

(76) Inventor: Josef Hintersehr, Griesheim (DE)

Correspondence Address: DeMont & Breyer, LLC, 100 Commons Way, Ste. 250, Holmdel, NJ, 07733, US

(21) Appl. No.: 12/603,632

(22) Filed: Oct. 22, 2009

(30) Foreign Application Priority Data
Dec. 9, 2008 (DE) 10 2008 060 860.2

(51) Int. Cl. A61C 13/003; A61C 13/08; G06F 17/50

(52) U.S. Cl. 433/172; 433/201.1; 700/98; 700/119

(57) ABSTRACT

The invention relates to a method for fabricating dental components. A set of geometric data is provided for the three-dimensional description of at least one desired dental component, and based on these geometric data a three-dimensional CAD model of the dental component is created. The CAD model processes the geometric data in the form of layer data to generate numerous CAD model layers which are suitable for use in a laser sintering or laser melting process. The laser sintering or laser melting process is then carried out, based on the layer data for each individual CAD model layer, and with computer assistance a powdered material is correspondingly applied in layers on a fabrication platform. Following the laser sintering or laser melting process, the body of the dental component having the resulting layered construction is transferred to a heat treatment oven, is subjected to heat treatment, and is subsequently cooled.

### FIELD OF INVENTION

The invention relates to a method for fabricating dental components such as implants, dental restorations, crowns, bridges, or bridge frameworks, for example.

### BACKGROUND OF THE INVENTION

It is known to use laser sintering or laser melting processes for fabricating dental components such as implants, dental restorations, crowns, bridges, or bridge frameworks, depending on the starting material to be processed and the temperature used. The principle of laser sintering (“selective laser sintering” (SLS)) is based on solidification by localized sintering of powder particles; for laser melting (“selective laser melting” (SLM)) these powder particles are locally melted. As a result of the layered construction of the body of a dental component on a fabrication platform, these processes are essentially independent of the geometric complexity of a dental component to be fabricated. Since the laser sintering and laser melting processes are known as such to one skilled in this field, no further description is provided.

After the laser sintering or laser melting process is completed, the body of the dental component is released from the fabrication platform, and before use in the oral region as a dental component is typically subjected to a fairly involved surface aftertreatment, in particular also to correct inaccuracies which result during the layered construction.

### SUMMARY OF THE INVENTION

The object of the invention is to further minimize currently existing production tolerances and to increase efficiency during fabrication of dental components which use a laser sintering or laser melting process.

The object is achieved according to the invention by use of a method for fabricating dental components, such as dental implants, dental restorations, crowns, and/or bridge frameworks, for example, comprising the following steps.

A set of geometric data is provided, with computer assistance, for the three-dimensional description of at least one desired dental component, and based on these geometric data a three-dimensional CAD model of the dental component is created. The CAD model processes the geometric data in the form of layer data to generate numerous CAD model layers which are suitable for use in a laser sintering or laser melting process. The laser sintering or laser melting process is then carried out, based on the layer data for each individual CAD model layer, and with computer assistance a powdered material is correspondingly applied in layers on a fabrication platform. Following the laser sintering or laser melting process, the body of the dental component having the resulting layered construction is transferred to a heat treatment oven, is subjected to heat treatment, and is subsequently cooled. After the body of the dental component has cooled, the previously provided set of geometric data for the three-dimensional description of the desired dental component is used once again to perform computer-assisted surface aftertreatment by erosion or in particular milling of the body of the dental component, and the body of the dental component is released from the fabrication platform only after this surface aftertreatment is complete.

Significant advantages of the invention are that, as the result of the heat treatment immediately following the laser sintering or laser melting process and subsequent cooling, the material structure of the body of the dental component undergoes relaxation on the fabrication platform, thus allowing surface aftertreatment of the body of the dental component which is still on the fabrication platform to be carried out once again with computer assistance, i.e., essentially automatically and with precision, once more using the three-dimensional geometric data already present for creating the CAD model.

A dental component which is thus present following release or removal of the body of the dental component from the fabrication platform therefore has much lower production tolerances, and the overall fabrication is carried out in an efficient manner.

Within the scope of the invention there are alternatives to create with computer assistance a new set of geometric data provided for the three-dimensional description of at least one desired dental component, or to use a previously created set, and to create a new three-dimensional CAD model of the dental component provided on the basis of these geometric data, or to use a previously created CAD model, and to generate new CAD model layers by processing the geometric data as layer data, or to use previously generated model layers.

In order to make practical use of the invention for a variety of different dental components, it is further preferably provided to use an intraoral scanning process and/or an extraoral digitizing process on an application-specific basis for creating a set of three-dimensional geometric data.

In order to use the invention even more efficiently, it is further provided that the body of the dental component constructed on the fabrication platform is composed of a plurality of dental component subbodies, each subbody being based on a subset of three-dimensional geometric data for a single dental component, and the set of three-dimensional geometric data being created from this plurality of subsets.

Furthermore, on an application-specific basis it has proven advantageous to use a plastic, a plastic-coated molding sand, or a metal or ceramic powder as powdered workpiece material for constructing a body of the dental component within the scope of the invention.

The invention further provides a dental component which is produced using a method described herein.

### BRIEF DESCRIPTION OF THE DRAWINGS

FIG. 1 shows examples of individual steps of a method for fabricating a dental component according to the invention.

### DETAILED DESCRIPTION

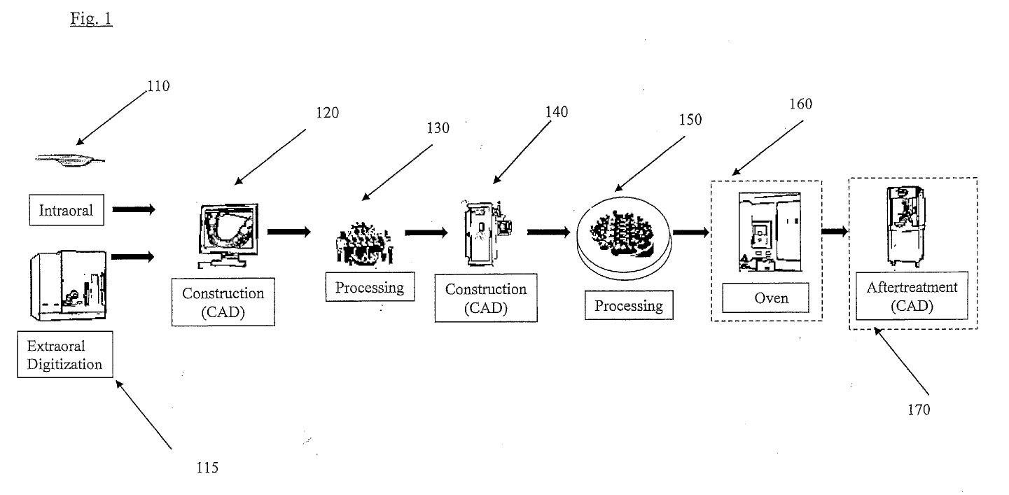

The invention is described in greater detail below with reference to a process diagram illustrated by way of example in FIG. 1, showing in a highly schematic fashion examples of individual steps of a method for fabricating a dental component according to the invention.

In a first method step at least one set of three-dimensional geometric data for at least one desired dental component is obtained or provided. For this purpose an intraoral scanning process 110 may be used, for example by means of a laser scanner which frequently has a pinlike design and is guided in the oral region, and measured or scanned data of the jaw, teeth, etc. recorded in the oral region are transmitted to a CAD-based data processing unit which processes 120 the received jaw and/or teeth data with computer assistance to create a CAD model (computer-aided design model) for a desired dental component such as an implant and restoration of a crown or bridge and bridge framework, and for generating the CAD model layers for layer data which may be used in a laser sintering or laser melting process. Additionally or alternatively, such jaw and/or teeth data may be obtained using an extraoral digitizing process 115 outside the oral region, for example in which first a plaster impression of a jaw, bite, or tooth is taken, and the necessary data are collected by extraoral measurement of this impression or a model based thereon.

After processing the provided three-dimensional data into layer data and subsequent creation of a computer-assisted model by use of a computer-assisted modeling process 120, the layer data for the CAD model 130 for the at least one dental component are supplied to a further CAD-supported data processing unit which is designed to carry out a laser sintering or laser melting process 140.

Within the scope of the invention there are alternatives to create with computer assistance a new set of geometric data provided for the three-dimensional description of at least one desired dental component, or to use a previously created set, and to create a new three-dimensional CAD model of the dental component provided on the basis of these geometric data, or to use a previously created CAD model, and to generate new CAD model layers by processing the geometric data as layer data, or to use previously generated model layers.

As shown in FIG. 1, the CAD model and therefore also the layer data for the CAD model 130 include a plurality of dental component subbodies, each subbody being based on a subset of three-dimensional geometric data for a single dental component, and the set of three-dimensional geometric data being created from this plurality of subsets.

During the laser sintering or laser melting process 140, using the CAD-supported data processing unit, based on the layer data for each individual CAD model layer and with computer assistance a powdered material is correspondingly applied in layers on a fabrication platform, which may be received from the CAD-supported data processing unit in the form of a component substrate, to construct a three-dimensional body of the desired dental component.

A plastic material, a plastic-coated mold set, or a metal or ceramic powder has proven to be practical as powdered workpiece material for constructing a body of the dental component which is applied in layers on the fabrication platform for fabricating the body of the dental component.

Therefore, in the present case a plurality of dental component subbodies is applied to the fabrication platform as the body of the dental component.

After the laser sintering or laser melting process is completed, the resulting body of the dental component together with the fabrication platform as an intermediate product 150 is first delivered to a heat treatment oven 160, and as a result of the heat treatment of the intermediate product 150 the material structure undergoes relaxation. After cooling, the set of three-dimensional geometric data originally provided or created for the desired dental component is used to carry out a CAD-supported surface aftertreatment 170, advantageously by erosion or milling in particular. The body of the dental component is not removed from the fabrication platform until this surface aftertreatment is completed, so that the dental component or also the plurality of single dental components is present in the finished state for use in the oral region.

1. Method for fabricating dental components such as dental implants, dental restorations, crowns, and/or bridge frameworks, the method comprising:
providing, with computer assistance, a set of geometric data for a three-dimensional description of a dental component;
creating, with computer assistance, a three-dimensional computer-aided design (CAD) model of the dental component based on the provided geometric data;
generating multiple CAD model layers from the CAD model by processing the provided geometric data as layer data, the multiple CAD model layers being suitable for use of a laser sintering or laser melting process;
utilizing the laser sintering or laser melting process based on the layer data for each individual CAD model layer, and correspondingly applying, with computer assistance, a powdered material in layers on a fabrication platform;
following the laser sintering or laser melting process, transferring the body of the dental component together with the fabrication platform to a heat treatment oven;
carrying out heat treatment on the body of the dental component together with the fabrication platform;
cooling the previously heat-treated body of the dental component together with the fabrication platform;
after cooling of the previously heat-treated body of the dental component, carrying out computer-assisted surface aftertreatment, of the body of the dental component, once again using the provided set of geometric data for the three-dimensional description of the dental component; and
after carrying out the computer-assisted surface aftertreatment, removing or releasing the body of the dental component from the fabrication platform.

2. Method according to claim 1, characterized in that
a new set of geometric data provided for the three-dimensional description of the dental component is created with computer assistance, or a previously created set is used for this set of geometric data,
a new three-dimensional CAD model of the dental component, provided on the basis of these geometric data, is created, or a previously created CAD model is used for the CAD model, and/or
new CAD model layers are generated by processing the geometric data as layer data, or previously generated model layers are used to generate the CAD model layers.

3. Method according to claim 1, characterized in that an intraoral scanning process is used to provide the set of geometric data.

4. Method according to claim 1, characterized in that an extraoral digitizing process is used to provide the set of geometric data.

5. Method according to claim 1, characterized in that the body of the dental component constructed on the fabrication platform is composed of a plurality of dental component sub-bodies, each sub-body in the plurality being based on a subset of three-dimensional geometric data for a single dental component, and the provided set of geometric data being created from subsets of three-dimensional data corresponding to the sub-bodies in the plurality.

6. Method according to claim 1, characterized in that a plastic, a plastic-coated molding sand, or a metal or ceramic powder is used as powdered workpiece material.

7. Dental component produced using a method according to claim 1.

8. Method according to claim 1, wherein the computer-assisted surface aftertreatment involves erosion.

9. Method according to claim 1, wherein the computer-assisted surface aftertreatment involves milling.
